(19) United States
(12) Patent Application Publication
(10) Pub. No.: US 2024/0306553 A1
(43) Pub. Date: Sep. 19, 2024

(54) BALER AND METHOD OF BINDING A BALE

(71) Applicant: Kuhn-Geldrop B.V., Geldrop (NL)

(72) Inventor: Jan Johannes Judocus HOL, Bokel (NL)

(73) Assignee: Kuhn-Geldrop B.V., Geldrop (NL)

(21) Appl. No.: 18/604,981

(22) Filed: Mar. 14, 2024

(30) Foreign Application Priority Data
Mar. 14, 2023 (GB) 2303724.5

(51) Int. Cl. A01F 15/14; A01F 15/12; A01F 15/04

(52) U.S. Cl. CPC A01F 15/145; A01F 15/12; A01F 15/04

(57) ABSTRACT

A baler including a binding system including a twine holder including a first rotary disk including a first clamping notch forming a first knot and a second clamping notch forming a second knot, the depth of the second notch being greater than that of the first notch, a retainer adjacent a periphery of the first rotary disk, a clamping plate cooperating with the retainer to hold the twines and a drive system rotating the first rotary disk to clamp twine located in at least one of the clamping notches against the retainer. The retainer applies a greater clamping force on the twines located in the first notch than those located in the second notch. When the twines are located in the second notch, the first rotary disk rotates the twines beyond an end of the clamping plate, thereby releasing the twines from the clamping plate and the retainer.

The present invention relates to a baler and a method of binding a bale. The invention also relates to a baler comprising a bale forming channel, a reciprocating plunger and a binding system for binding a bale in the bale forming channel.

It is known to provide a baler for pressing bales with a reciprocal plunger, whereby the bale is bound by tying a plurality of twine loops around the bale.

The twine for binding the bale is supplied by two supplies per twine loop, one for the top side and one for bottom side of the bale. The closing of the loop around the finished bale is done by tying two knots. The basic principle of such a bale binding system is well described in U.S. Pat. No. 4,074,623 and EP1584227.

U.S. Pat. No. 4,074,623 is an example of a binding system as described above in which the twines are tied with a conventional knot. EP1584227 is an example of a binding system as described above in which the twines of the second knot are tied with a loop knot so as not to have loose twine ends cut from the strands between the first and second knot.

The binding of the bale is necessary to hold the bale under compression; the expansion of the bale as it is ejected from the baling channel puts a lot of tension on the binding twine. The breaking resistance of the binding twine and the knot(s) in the twine determine the maximum possible compression of the material in the bale. A high compression is desirable as the higher the compression the more efficiently the bale material can be stored and transported.

EP1584227 suggests solutions for releasing the twine strands before the cutting of the second knot to form a loop knot as a second knot. The solutions suggested are complicated and not sufficiently reliable with different twine strengths and brands and will require many changes to the actual knotter design and are therefore not retrofittable on an existing knotter.

It is an object of the present invention to provide a solution to one or more of the problems set out above, thereby allowing the compression of the bale to be increased without causing the twine loops to break and/or avoiding or mitigating one or more of the disadvantages of the system described in EP1584227.

According to certain aspects of the present invention there are provided a binding system for a baler, a baler that includes a binding system, and a method for binding a bale as defined by the claims.

According to a first aspect there is provided a baler according to claim 1. The invention for example, enables a bale to bound in a manner such that at least the second knot comprises a loop knot, which enables compression of the bale to be increased without causing the twine loops to break, by providing a relatively simple mechanical solution that reliably produces loop knots.

According to another aspect there is provided a baler.

The baler can include a bale forming chamber and a reciprocating plunger configured to compress bale material in the bale forming channel to form a bale.

The baler can include a binding system for binding the bale in a bale forming channel of a baler with a pair of twines that pass around opposite sides of the bale.

The binding system can include a knotter including a rotary bill hook having a rotational axis. The knotter can include a twine holder. The knotter can include a twine cutter. The knotter can include a stripper element arranged to remove at least some knots from the bill hook.

The binding system can be configured to tie a first knot and a second knot successively in the twines during one full operating cycle of the binding system. At least the second knot can be a loop knot.

The bill hook can be rotatable between a first position in which the bill hook engages the twines and a second position in which a knot formed by the knotter is stripped from the bill hook by the stripper element.

The twine holder can include a first rotary disk. The first rotary disk can include a first clamping notch arranged to receive the twines during formation of the first knot. The first rotary disk can include a second clamping notch arranged to receive the twines during formation of the second knot.

The twine holder can include a retainer positioned adjacent a periphery of the first rotary disk. The retainer can be arranged to cooperate with the first rotary disk to hold the twines at least during a part of the operating cycle.

The twine holder can include a clamping member, such as a clamping plate. The clamping plate can be arranged to cooperate with the retainer to hold the twines. The clamping plate can be arranged to cooperate with the retainer to hold the twines at least until the second knot is stripped off the bill hook by the stripper element.

The binding system can include a drive system. The drive system can be arranged to rotate the first rotary disk to clamp the twines in one of the first and second notches against the retainer and/or clamping plate.

The retainer and/or clamping plate, at least during the stripping off of the knots by the stripper element, can be arranged to apply a greater clamping force on the twines in a condition wherein the twines are located in the first clamping notch than the clamping force applied on the twines in a condition wherein the twines are located in the second clamping notch.

In some embodiments, the depth of the second clamping notch, relative to an outer circumference of the first rotary disk, is greater than the depth of the first clamping notch.

The twine holder can include a second rotary disk. The second rotary disk can be fixed for rotation with the first rotary disk about a rotation axis. The second rotary disk can include a first clamping notch. The second rotary disk can include a second clamping notch. The clamping plate can be arranged to cooperate with the retainer to hold the twines located in one of the notches of the second rotary disk.

The notch in which the twines are located being determined by the operational condition of the binding system. For example, during formation of the first knot the twines are located in the first clamping notch of the first rotary disk, and optionally are located in the first clamping notch of the second rotary disk. During formation of the second knot the twines are located in the second clamping notch of the first rotary disk, and optionally are located in the second clamping notch of the second rotary disk.

The first rotary disk can include a plurality of first clamping notches. The first rotary disk can include a plurality of second clamping notches. The first and second notches can alternate around the periphery of the first rotary disk. The second rotary disk can include a plurality of first clamping notches. The second rotary disk can include a plurality of second clamping notches. The first and second notches alternate around the periphery of the second rotary disk.

The first and second rotary disks can be fixed to one another such that the first clamping notch in the first rotary disk is rotationally aligned with the first clamping notch in the second rotary disk. The first and second rotary disks can be fixed to one another such that the second clamping notch in the second rotary disk is rotationally aligned with the second clamping notch in the second rotary disk. For embodiments wherein each of the first and second rotary disks includes a plurality of first clamping notches and a plurality of second clamping notches, each first clamping notch in the first rotary disk can be rotationally aligned with a respective one of the first clamping notches in the second rotary disk, and each second clamping notch in the first rotary disk can be rotationally aligned with a respective one of the second clamping notches in the second rotary disk.

The clamping notches can be arranged asymmetrically around the periphery of the first rotary disk. Optionally, the clamping notches can be arranged asymmetrically around the periphery of the second rotary disk.

The clamping plate can be positioned between the first and second rotary disks.

The first rotary disk can be arranged to rotate relative to the clamping plate. Optionally the second rotary disk can be arranged to rotate relative to the clamping plate.

The retainer can be resiliently biased towards the center of the first rotary disk. Optionally, the retainer can be resiliently biased towards the center of the second rotary disk.

In a condition wherein the twines are located in the second notch of the first rotary disk, and the second knot is being stripped off the bill hook by the stripper element, the first rotary disk can be arranged to rotate the twines beyond an end of the clamping plate, thereby releasing the twines from the grip of the clamping plate and/or the retainer. Optionally, in a condition wherein the twines are located in the second notch of the second rotary disk, the second rotary disk can be arranged to rotate the twines beyond an end of the clamping plate, thereby releasing the twines from the grip of the clamping plate and/or the retainer.

At least part of the clamping plate can include a curved outer surface. In a condition wherein the twines are located in the second notch, the first rotary disk can be arranged to rotate the twines beyond the curved outer surface, thereby releasing the twines from the grip of the clamping plate and/or the retainer. Optionally, in a condition wherein the twines are located in the second notch of the second rotary disk, the second rotary disk can be arranged to rotate the twines beyond the curved outer surface, thereby releasing the twines from the grip of the clamping plate and/or the retainer.

The curved outer surface comprises an arc having a radius that extends from a rotation axis of the first rotary disk, and optionally the second rotary disk, to the curved outer surface.

The radius defining the arc of the outer surface of the clamping plate, can have a radial distance that is less than or equal to a radial distance from the rotation axis of the first rotary disk, and optionally the second rotary disk, to the inner most part of the first notch.

The radius defining the arc of the outer surface of the clamping plate, can have a radial distance that is greater than a radial distance from the rotation axis of the first rotary disk, and optionally the second rotary disk, to the inner most part of the second notch.

The stripper element can include a screen. The screen can be arranged to move with the stripper element. The screen can be arranged to support the twines during at least part of the first knot forming process and/or to support the twines during at least part of the second knot forming process.

The twine can be located in a first position on the screen. The twine can be located in a second position on the screen. The first position is different from the second position. The selection between the first and second positions on the screen can depend on the rotational position of the first rotary disk, and optionally the rotational position of the second rotary disk. The first position can be a position in which the twine is cuttable by the cutter. The second position can be a position in which the twine is not cuttable by the cutter.

The screen can include an upper surface. The first position can be located on the upper surface. The screen can include a side surface. The side surface can be arranged perpendicularly to the upper surface. The second position can be located on the side surface.

Rotation of the second clamping notch beyond an end of the clamping plate and/or beyond the curved outer surface can be achieved by locating an additional gear stretch on a drive disk, for example after a gear stretch for driving rotation of the first rotary disk for forming the second knot, in the direction of rotation of the drive disk. For embodiments, including a second rotary disk that is fixed for rotation with the first rotary disk, the gear stretch drives rotation of the first rotary disk also rotates the second rotary disk.

In some embodiments, the first knot comprises a loop knot. In embodiments, wherein the first knot comprises a loop knot and the second knot comprises a loop knot, the compression of the bale can be increased further without causing the twine loops to break.

The clamping plate can be pivotally attached to a mounting. The clamping plate can be arranged to pivot with respect to the first rotary disk, and optionally the second rotary disk, thereby adjusting the clamping force applied to the twines. The clamping plate can be arranged to pivot to a position wherein the twines are released.

The twine holder can include an actuation formation that is arranged to pivot the clamping plate. The actuation formation can be arranged to pivot the clamping plate to the position wherein the twines are released.

The actuation formation can comprise a protrusion. The protrusion can be located on the first rotary disk. The protrusion can be located on the second rotary disk. The protrusion can be located on a member, such as a hub, that connects the first rotary disk to the second rotary disk. The protrusion can be located on the clamping plate, for example on an inner surface of the clamping plate. The inner surface can face towards the hub.

In some embodiments the twine holder includes a second actuation formation that is arranged to pivot the clamping plate. The second actuation formation can be arranged to pivot the clamping plate to the position wherein the twines are released. The second actuation formation can be arranged to interact with the first actuation formation to pivot the clamping plate to the position wherein the twines are released. For example, the actuation formation can be arranged to rotate relative to the second actuation formation. The second actuation formation can be arranged to interact with the actuation formation in a condition wherein the second actuation formation is rotationally aligned with the actuation formation.

The second actuation formation can comprise a second protrusion. The second protrusion can be located on the first rotary disk. The second protrusion can be located on the second rotary disk. The second protrusion can be located on a member, such as a hub, that connects the first rotary disk to the second rotary disk. The second protrusion can be located on the clamping plate, for example on an inner surface of the clamping plate.

According to another aspect, there is provided a method according to claim 21. The invention for example, enables a bale to bound in a manner such that at least the second knot comprises a loop knot, which enables compression of the bale to be increased without causing the twine loops to break, by providing a relatively simple mechanical solution that reliably produces loop knots.

According to another aspect, there is provided a method for binding a bale in a baler.

The method can include providing a baler. The baler can include a bale forming channel. The baler can include a reciprocating plunger that compresses bale material in the bale forming channel to form a bale. The baler can include a binding system that binds a bale in the bale forming channel with a pair of twines that pass around opposite sides of the bale.

The binding system can include a drive system.

The binding system can include a knotter. The knotter can include a rotary bill hook that has a rotational axis. The knotter can include a twine cutter. The knotter can include a twine holder. The twine holder can include a first rotary disk. The first rotary disk can include a first clamping notch. The first rotary disk can include a second clamping notch. The twine holder can include a retainer. The twine holder can include a clamping plate. The clamping plate can have a curved outer surface.

The method can include tying a first knot and a second knot successively in the twines during one full operating cycle of the binding system.

Forming the first knot can include: locating the twines in the first clamping notch; clamping the twines between the retainer and the clamping member; the rotary bill hook tying a first knot in the twines; and the cutter cutting the twines.

Forming the second knot can include locating the twines in the second clamping notch; the drive system rotating the first rotary disk to clamp twines, the retainer clamping the twines to the curved outer surface of the clamping member as the twines move over the curved surface of the clamping member; and the bill hook tying the second knot, wherein the second knot is a loop knot. Forming the second knot can include the retainer releasing the twines, or at least significantly reducing the clamping force applied to the twines, towards the end of the second knot forming cycle as the twines pass an end of the clamping member and/or an end of the curved surface of the clamping member, thereby preventing the twine cutter from cutting the twines.

The binding system can include a stripping element arranged to strip the first and/or second knot from the bill hook. The stripping element can include a screen. The method can include locating twine on the screen in a first position when forming the first knot; and locating twine on the screen in a second position when forming the second knot.

The baler can be arranged according to any configuration described herein.

According to a second aspect there is provided a baler. The baler can comprise a bale forming channel. The baler can comprise a reciprocating plunger configured to compress bale material in the bale forming channel to form a bale. The baler can comprise a binding system for binding a bale in the bale forming channel.

The binding system can be arranged to bind the bale with a pair of twines that pass around opposite sides of the bale.

The binding system can include a knotter. The knotter can include a rotary bill hook. The rotary bill hook can have a rotational axis. The knotter can include a twine holder. The knotter can include a twine cutter. The knotter can include a stripper element to remove at least some knots from the bill hook. The stripper element can include a twine cutter that is arranged to cut the twines in some operational conditions.

The binding system can be configured to tie a first knot and a second knot successively in the twines during one full operating cycle of the binding system.

The bill hook can be rotatable between a first position in which the bill hook engages the twines and a second position in which a knot formed by the knotter is stripped from the bill hook by the stripper element.

The twine holder can include a first rotary disk.

The twine holder can include a second rotary disk. Optionally the twine holder comprises at least two rotary disks, for example at least the first and second rotary disks.

The first and/or second rotary disks can rotate about a rotation axis.

The first rotary disk can include a first clamping notch. The first rotary disk can include a second clamping notch.

The second rotary disk can include a first clamping notch. The second rotary disk can include a second clamping notch.

For embodiments including first and second rotary disks, the first and second rotary disks can be locked for rotation with one another about the rotation axis.

Typically, the first and second rotary disks are similar. Typically, the first and second rotary disks are fixed to one another such that at least one first notch in the first rotary disk is rotationally aligned with at least one first notch in the second rotary disk. Typically, the first and second rotary disks are fixed to one another such that at least one second notch in the second rotary disk is rotationally aligned with at least one second notch in the second rotary disk.

The twine holder can comprise a retainer located adjacent a periphery of the first and/or second rotary disk. The retainer can be resiliently biased towards the center of the first and/or second rotary disks. Having at least two rotary disks helps the retainer to clamp the twines to the rotary disks.

The binding system can include a drive system for rotating the first and/or second rotary disks to clamp twines in at least one of the first and second clamping notches against the retainer. For example, the first notch can clamp the twines during formation of the first knot. The second notch can clamp the twines during formation of the second knot.

The depth of the second notch relative to the outer circumference of the rotary disks can be greater than the first notch. This can provide, for example, a lesser holding force on the twines located in the second notch, when compared with a holding force on the twines when located in the first notch. This can occur because the biasing force of the retainer decreases towards the greater depth of the second notch.

Optionally the twine holder comprises a clamping plate. The clamping plate can be arranged to cooperate with the retainer to hold the twines. The clamping plate can be positioned between the first and second disks. The clamping plate is preferably a fixed component, for example can be fixed to a housing or mount. That is, in some embodiments, the clamping plate does not rotate with the rotary disks. The first and/or second rotary disks rotate relative to the clamping plate.

Optionally, when the twines are located in the second notch, the first and/or second rotary disks can be arranged to rotate the twines beyond an end of the clamping plate, thereby releasing the twines from the grip of the clamping plate and the retainer. This can occur, for example at the end of the second knot forming process.

At least part of the clamping plate can include a curved outer surface. For example, the curved outer surface can comprise an arc. The arc can have a radius, which extends from the rotation axis of the first and/or second rotary disks to the curved outer surface. When the twines are located in the second notch, the first and/or second rotary disks can be arranged to rotate the twines beyond the curved surface thereby releasing the twines from the grip of the clamping plate and the retainer.

The radius defining the arc of the outer surface of the clamping member, can have a radial distance that is approximately equal to a radial distance from the rotation axis of the first and/or second rotary disks to the inner most part of the second notch. This helps to clamp the twine during the first part of the formation of the second knot between the clamping plate and the retainer.

The radius defining the arc of the outer surface of the clamping member, can have a radial distance that is less than or equal to a radial distance from the rotation axis of the first and/or second rotary disks to the inner most part of the second notch. This helps to clamp the twine during the first part of the formation of the second knot between the clamping plate and the retainer.

The radius defining the arc of the outer surface of the clamping member, can have a radial distance that is greater than or equal to a radial distance from the rotation axis of the first and/or second rotary disks to the inner most part of the first notch. This helps to clamp the twine during the first part of the formation of the second knot between the clamping plate and the retainer.

The radius defining the arc of the outer surface of the clamping member can be between the radii of the lower parts of the first and second notch as to clamp the twine during the first part of the formation of the second knot between the clamping plate and the retainer.

The first rotary disk can include a plurality of first clamping notches. The first rotary disk can include a plurality of second clamping notches. In some embodiments, the first rotary disk is arranged such that, a pair of first clamping notches are located diametrically opposite one another. In some embodiments, the first rotary disk is arranged such that, a pair of second clamping notches are located diametrically opposite one another. In some embodiments, the first rotary disk is arranged such that first and second notches alternate around the periphery of the first rotary disk.

The second rotary disk can include a plurality of first clamping notches. The second rotary disk can include a plurality of second clamping notches. In some embodiments, the second rotary disk is arranged such that, a pair of first clamping notches are located diametrically opposite one another. In some embodiments, the second rotary disk is arranged such that, a pair of second clamping notches are located diametrically opposite one another. In some embodiments, the second rotary disk is arranged such that first and second notches alternate around the periphery of the second rotary disk.

Optionally the clamping notches are arranged asymmetrically around the periphery of the first rotary disk.

Optionally the clamping notches are arranged symmetrically around the periphery of the first rotary disk.

The stripper element can include a screen. The screen is arranged to move with the stripper element. The screen can be arranged to support the twines during at least part of the first knot forming process. The screen can be arranged to support the twines during at least part of the second knot forming process. The screen can be located adjacent the cutting cutter.

Optionally, the screen can be configured so that the twine is guided by the screen. The twine can be located in first and second different positions on the screen depending on the rotational position of the rotary disk. The first position can be a position in which the twine can be cut by the cutter. The second position can be a position in which the twine cannot be cut by the cutter.

The screen can include an upper surface. The first position can be located on the upper surface. The screen can include a side surface and the second position is located on the second surface. The second surface can be arranged perpendicularly to the upper surface.

In some embodiments the twine holder comprises the first and second rotary disks each having a plurality of first and second clamping notches, the retainer located adjacent the peripheries of the first and second rotary disks, and the drive system for rotating the first and second rotary disks to clamp twines in at least one of the clamping notches against the retainer, and wherein the clamping notches are arranged asymmetrically around the periphery of the rotary disk.

In some embodiments the twine holder comprises the first rotary disk having a plurality of clamping notches, the retainer adjacent a periphery of the first rotary disk, the stripping element including the twine cutter and the screen, and the drive system for rotating the first rotary disk to clamp a twine in at least one of the clamping notches against the retainer, wherein the screen is configured so that the twine is guided across the screen in at least two different positions depending on the rotational position of the first rotary disk, the positions including a first position in which the twines can be cut by the twine cutter and a second position in which the twines cannot be cut by the twine cutter.

Optionally the rotation of the second notch beyond an end of the clamping plate and/or beyond the curved outer surface can be achieved by an extra gear stretch, for example located on a drive disk after a gear stretch for operating the rotary disks for forming the second knot. Thus, the extra gear stretch can be located on the drive disk in a manner that is angularly displaced from the gear stretch for forming the second knot.

According to another aspect there is provided a baler comprising a bale forming channel, a reciprocating plunger configured to compress bale material in the bale forming channel to form a bale, and a binding system for binding a bale in the bale forming channel with a pair of twines that pass around opposite sides of the bale, the binding system comprising a knotter that includes a rotary bill hook that has a rotational axis, a twine holder, a twine cutter, a stripper element and a twine holder, wherein the binding system is configured to tie a first knot and a second knot successively in the twines during one full operating cycle of the binding system, wherein the bill hook is rotatable between a first position in which the bill hook engages the twines and a second position in which a knot formed by the knotter is stripped from the bill hook by the stripper element.

The baler can be arranged according to any configuration described herein.

According to another aspect there is provided a binding system for a baler, the binding system including a twine holder comprising a first rotary disk including at least one first clamping notch for use when forming a first knot and at least one second clamping notch for use when forming a second knot, wherein the depth of the second notch is greater than the depth of the first notch, a retainer adjacent a periphery of the first rotary disk, and a drive system for rotating the first rotary disk to clamp twine located in at least one of the clamping notches against the retainer, wherein the retainer is arranged to apply a greater clamping force on the twines when the twines are located in the first notch than the clamping force applied on the twines when the twines are located in the second notch.

The binding system can be arranged according to any configuration described herein.

According to another aspect there is provided a binding system for a baler, the binding system including a twine holder comprising a first rotary disk including at least one first clamping notch for use when forming a first knot and at least one second clamping notch for use when forming a second knot, wherein the depth of the second notch is greater than the depth of the first notch, a retainer adjacent a periphery of the first rotary disk, a clamping plate arranged to cooperate with the retainer to hold the twines and a drive system for rotating the first rotary disk to clamp twine located in at least one of the clamping notches against the retainer, wherein the retainer is arranged to apply a greater clamping force on the twines when the twines are located in the first notch than the clamping force applied on the twines when the twines are located in the second notch, wherein when the twines are located in the second notch, the first rotary disk can be arranged to rotate the twines beyond an end of the clamping plate, thereby releasing the twines from the grip of the clamping plate and the retainer.

The binding system can be arranged according to any configuration described herein.

According to another aspect there is provided a binding system for a baler, the binding system including a twine holder comprises a first rotary disk having a plurality of clamping notches, a retainer adjacent a periphery of the first rotary disk, a stripping element including a twine cutter and a screen, and a drive system for rotating the first rotary disk to clamp a twine in at least one of the clamping notches against the retainer, wherein the screen is configured so that the twine is guided across the screen in at least two different positions depending on the rotational position of the first rotary disk, the positions including a first position in which the twines can be cut by the twine cutter and a second position in which the twines cannot be cut by the twine cutter.

The binding system can be arranged according to any configuration described herein.

According to another aspect there is provided a method for binding a bale in a baler. The method including providing a baler comprising a bale forming channel, a reciprocating plunger that compresses bale material in the bale forming channel to form a bale, and a binding system that binds a bale in the bale forming channel with a pair of twines that pass around opposite sides of the bale, the binding system comprising a knotter that includes a rotary bill hook that has a rotational axis, a twine holder, and a twine cutter. The method can include tying a first knot and a second knot successively in the twines during one full operating cycle of the binding system, wherein: the first and second knots are tied successively by a single bill hook, at least the second knot is a loop knot; and the twine holder releasing the twines towards the end of the second knot forming cycle, thereby preventing the twine cutter from cutting the twines.

The binding system can be arranged according to any configuration described herein.

The baler can be arranged according to any configuration described herein.

The method can include, the twine holder including a retainer and a first rotary disk having at least one first clamping notch and at least one second clamping notch, and a clamping member having a curved outer surface, wherein the twines are located in the second notch during the second knot forming process. The method can include the retainer clamping the twines to the curved outer surface of the clamping member as the twines move over the curved surface of the clamping member. The method can include the retainer releasing the twines, or at least significantly reducing the clamping force applied to the twines, when the twines pass an end of the clamping member.

The method can include, the binding system includes a stripping element arranged to strip the first and/or second knots from the bill hook, the stripping element includes a screen, and a drive system for rotating the first rotary disk to clamp a twine in at least one of the clamping notches against the retainer.

The method can include locating twine on the screen in a first position in which the twine can be cut by the twine cutter. The method can include locating twine on the screen in a second position in which the twine cannot be cut by the twine cutter.

Various embodiments of the invention will now be described by way of example with reference to the accompanying drawings, in which:

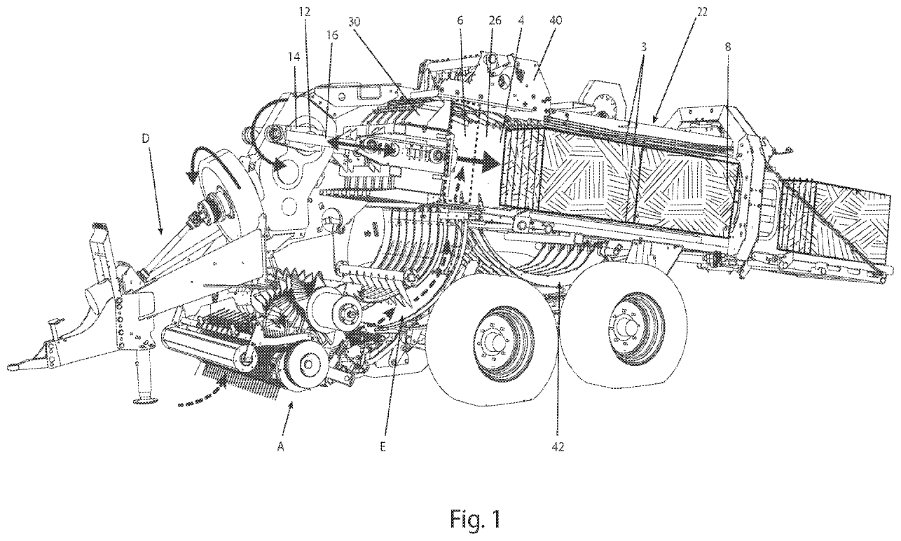

FIG. 1 is an isometric view showing the main components of a baling machine according to a first embodiment of the invention;

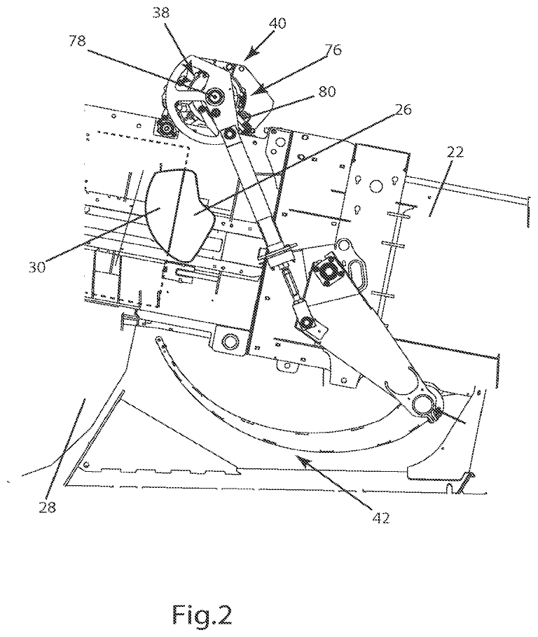

FIG. 2 is a partial sectional side view of part of the baler shown in FIG. 1;

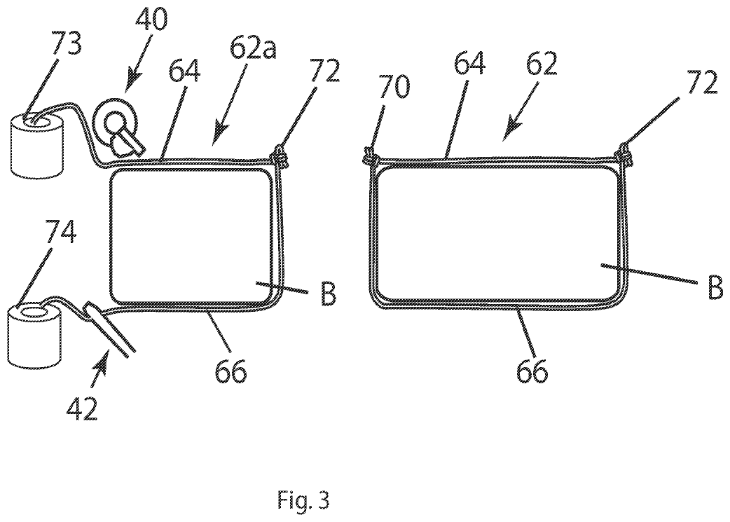

FIG. 3 depicts a twine loop tied around a finished bale and a pair of twines looped around a partially completed bale;

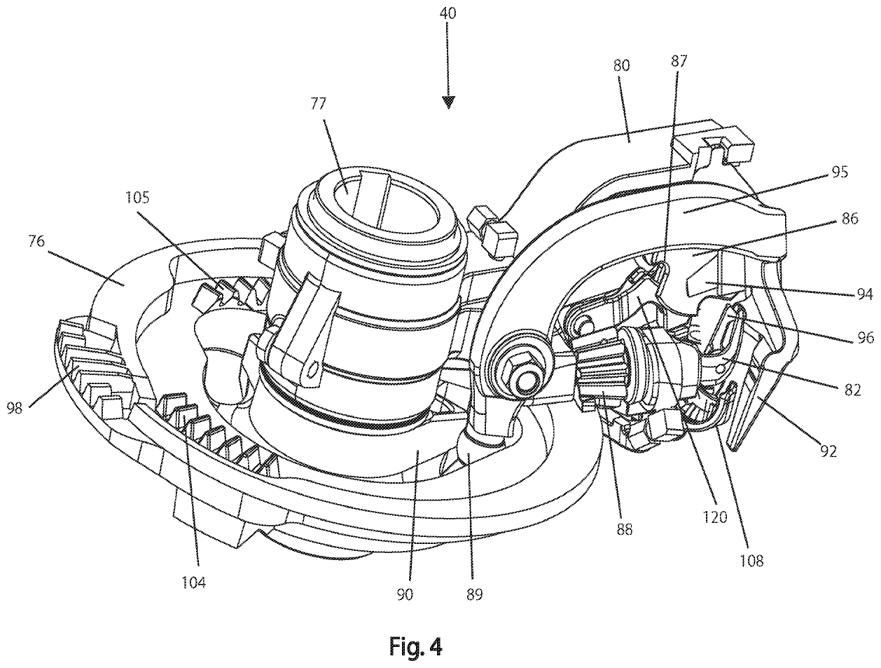

FIG. 4 is an isometric view of a knotter from a first angle included in the embodiment of FIG. 1;

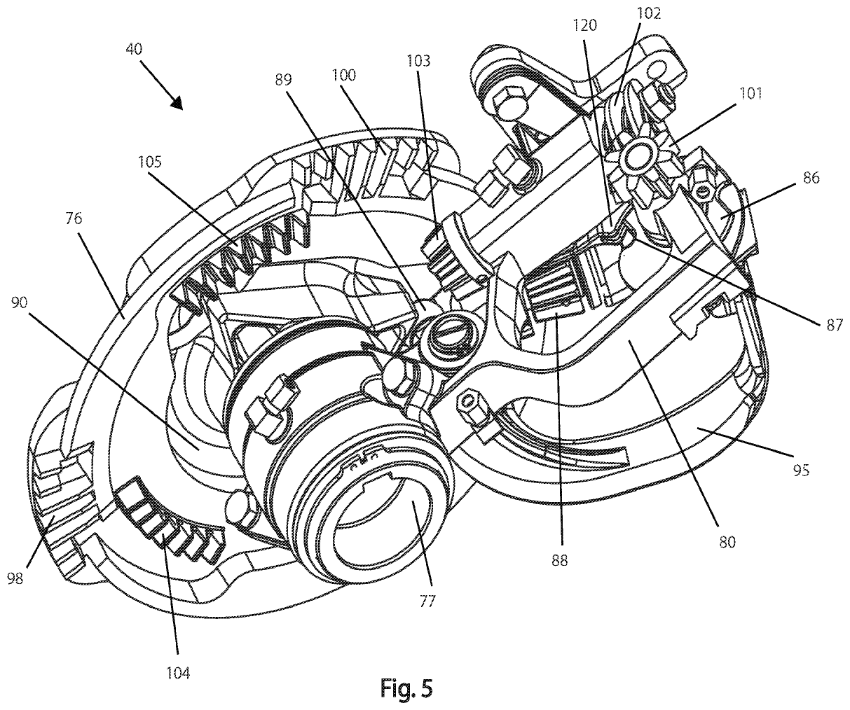

FIG. 5 is an isometric view of the knotter of FIG. 4 from a second angle;

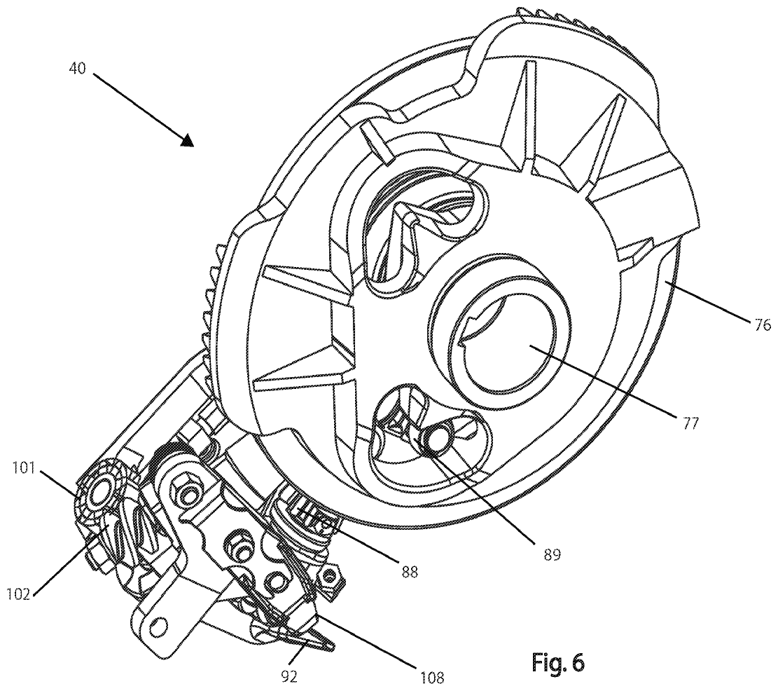

FIG. 6 is an isometric view of the knotter of FIG. 4 from a third angle;

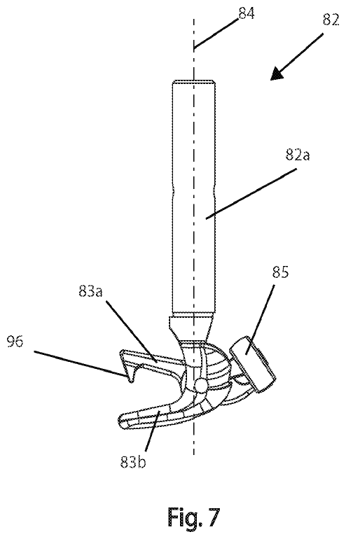

FIG. 7 is a side view of a bill hook included in the embodiment of FIG. 1;

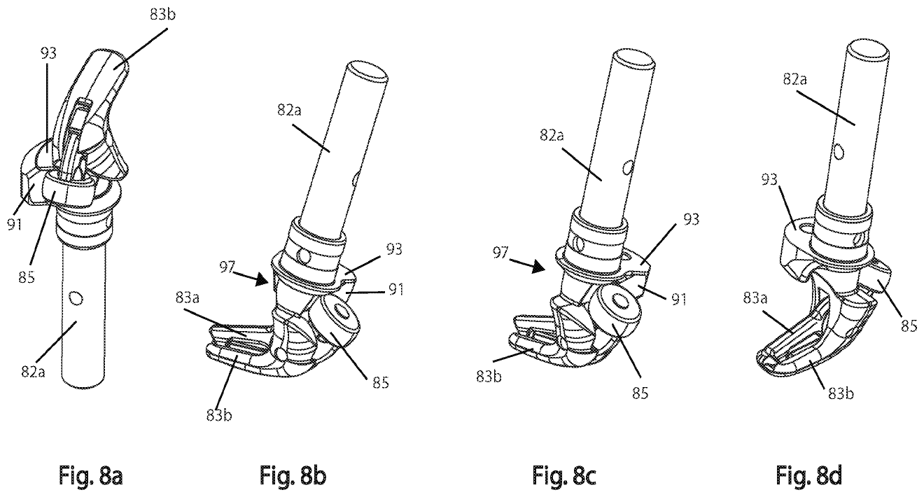

FIGS. 8a, 8b, 8c and 8d are isometric views of the bill hook of FIG. 7 in different operational conditions;

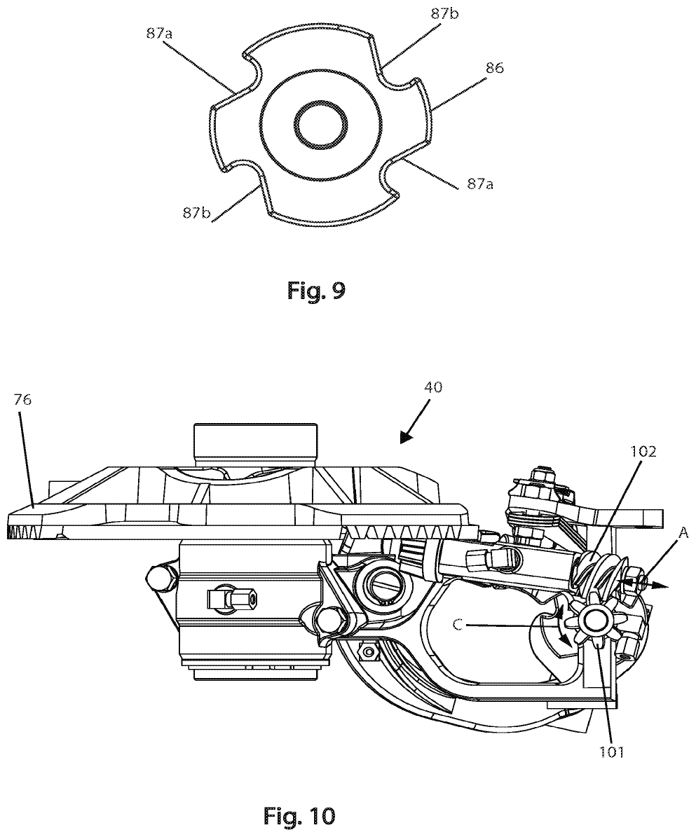

FIG. 9 is a plan view of a prior art twine disk having asymmetric notches for comparison purposes;

FIG. 10 is a side elevation of the knotter of FIG. 4 illustrating axial movement of the work wheel;

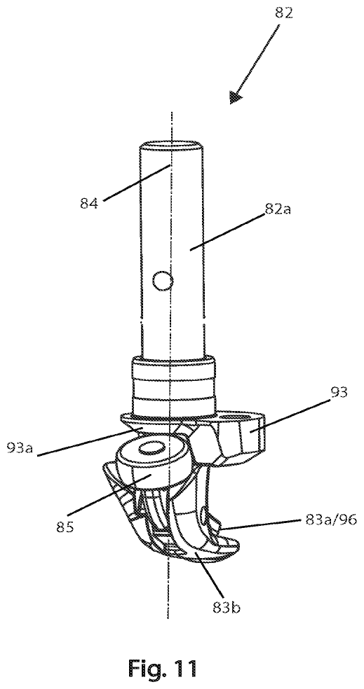

FIG. 11 is an isometric view of the bill hook of FIG. 7;

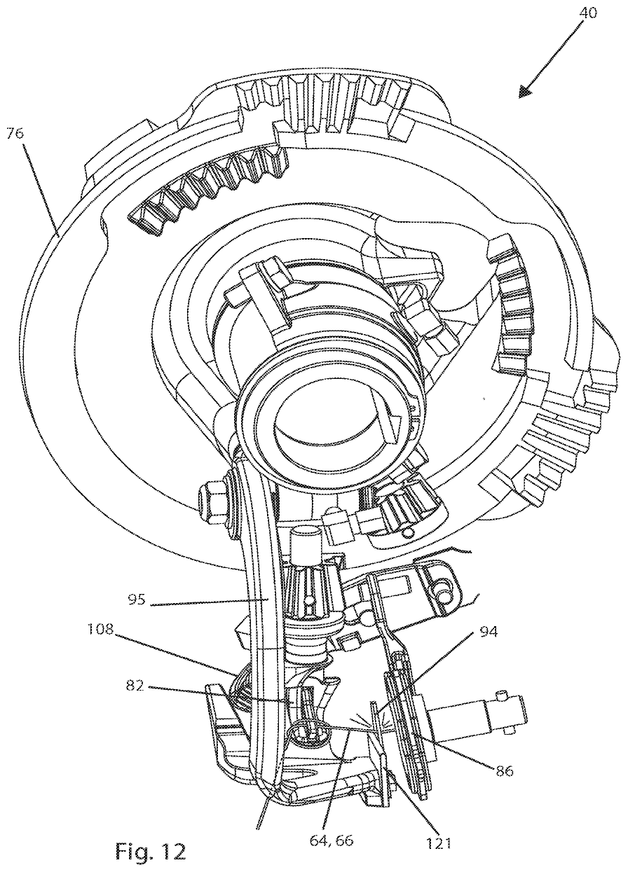

FIG. 12 is an isometric view of an alternative knotter that can be used in the embodiment of FIG. 1, and shows the twines, towards the end of a first knot forming process, being positioned in a first position on a screen so that twines are located in front of a cutter so that the cutter is able to cut the twines;

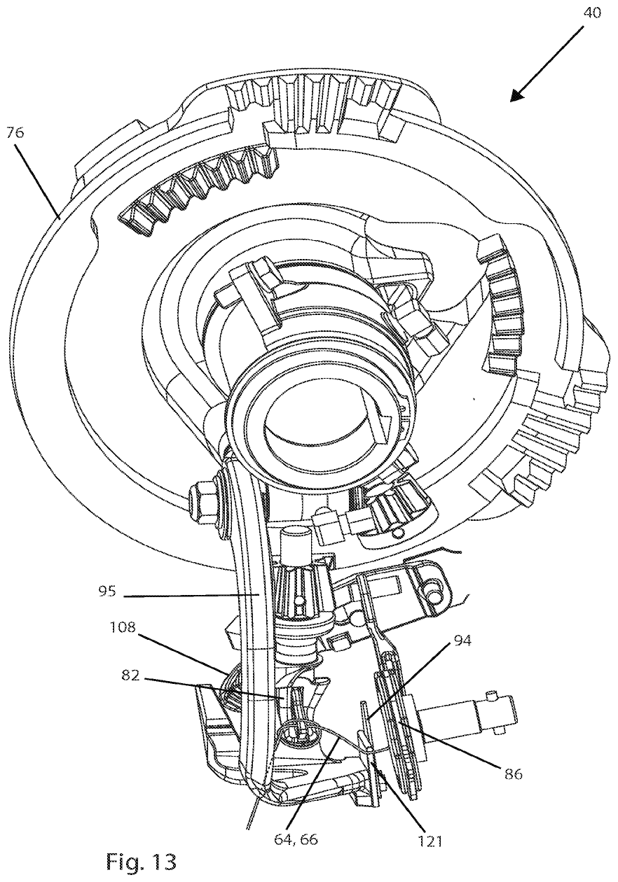

FIG. 13 is an isometric view of the alternative knotter of FIG. 12, showing the twines, towards the end of the second knot forming process, positioned in a second position across the screen in a manner such that the cutter is unable to cut the twines;

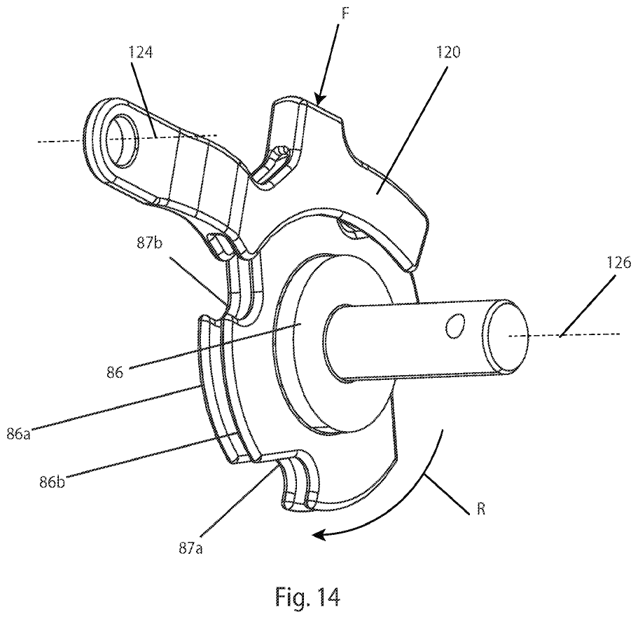

FIG. 14 is a 3D view of a twine holder accruing to the invention including first and second rotary disks, and a retainer, which shows how the retainer is arranged with respect to rotary disks;

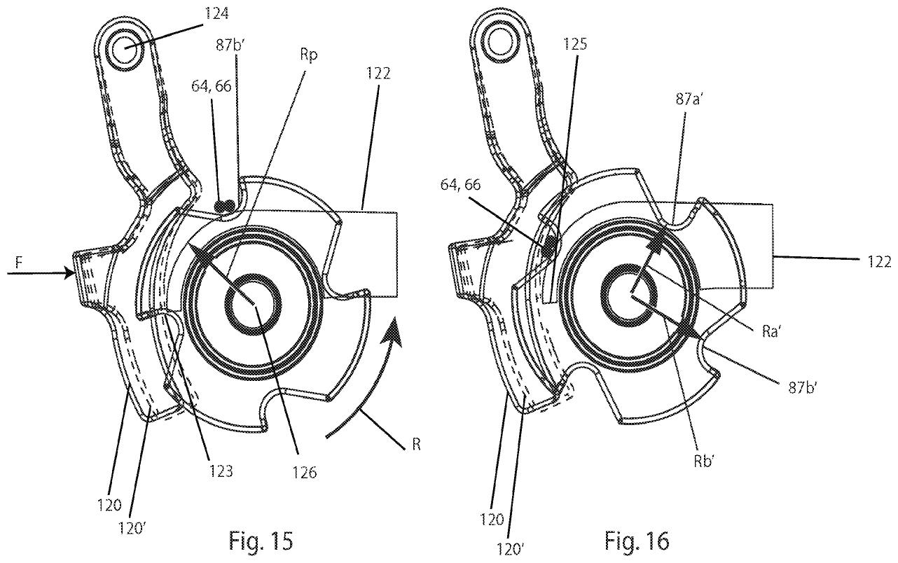

FIG. 15 is side view of the twine holder of FIG. 14, and shows the rotational position of the twine disks when the twines are placed into a first notch;

FIG. 16 shows the twine holder of FIG. 14, in particular the rotational position of the rotary disks during formation of the first knot;

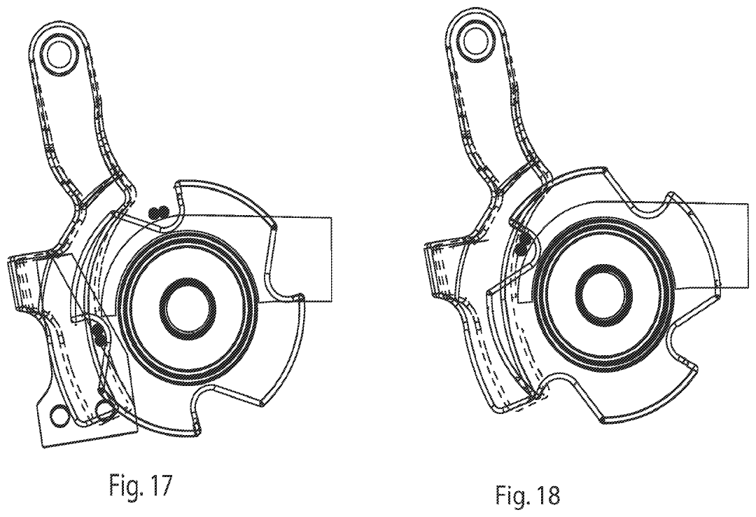

FIG. 17 shows the twine holder of FIG. 14, in particular the rotational position of the disks when a first knot is stripped off the bill hook, the twines are cut and the twines are put into a second notch, which has a different depth from the first notch;

FIG. 18 shows the twine holder of FIG. 14, in particular the rotational position of the disks during formation of the second knot;

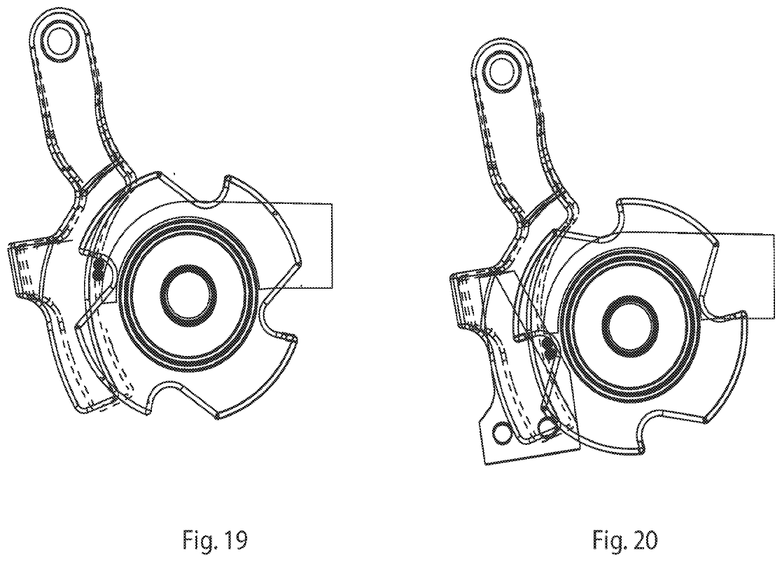

FIG. 19 shows the twine holder of FIG. 14, in particular the rotational position of the disks during formation of the second knot when the twines are put between the lower part of the bill hook and a catching element of the bill hook;

FIG. 20 shows the twine holder of FIG. 14, in particular the rotational position of the disks during stripping of a second knot from the bill hook, wherein the twines have moved past an end of a clamping plate and the twines are pulled out of the twine holder by the cutter;

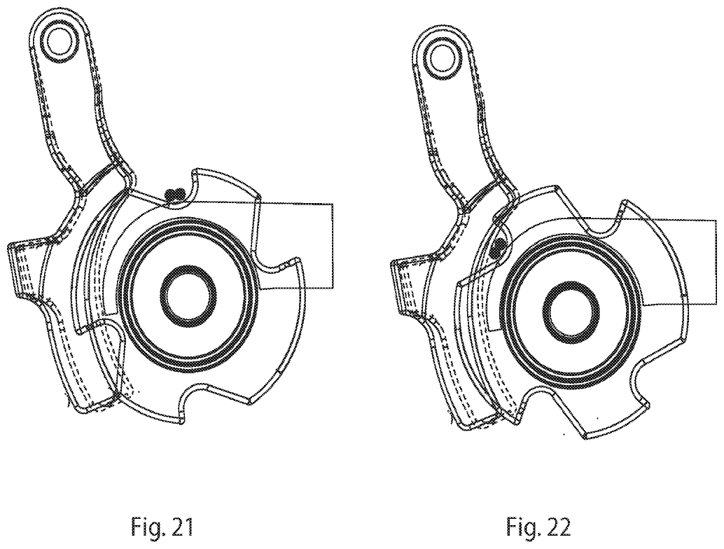

FIG. 21 shows a variant to the twine holder of FIG. 14 14, wherein each rotary disk has asymmetrically positioned notches;

FIG. 22 shows a variant to the twine holder of FIG. 15, wherein each rotary disk has asymmetrically positioned notches;

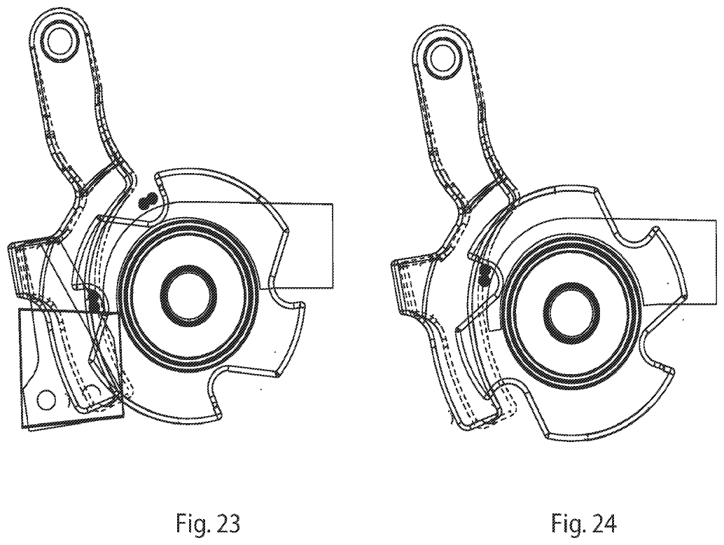

FIG. 23 shows a variant to the twine holder of FIG. 16, wherein each rotary disk has asymmetrically positioned notches;

FIG. 24 shows a variant to the twine holder of FIG. 17, wherein each rotary disk has asymmetrically positioned notches;

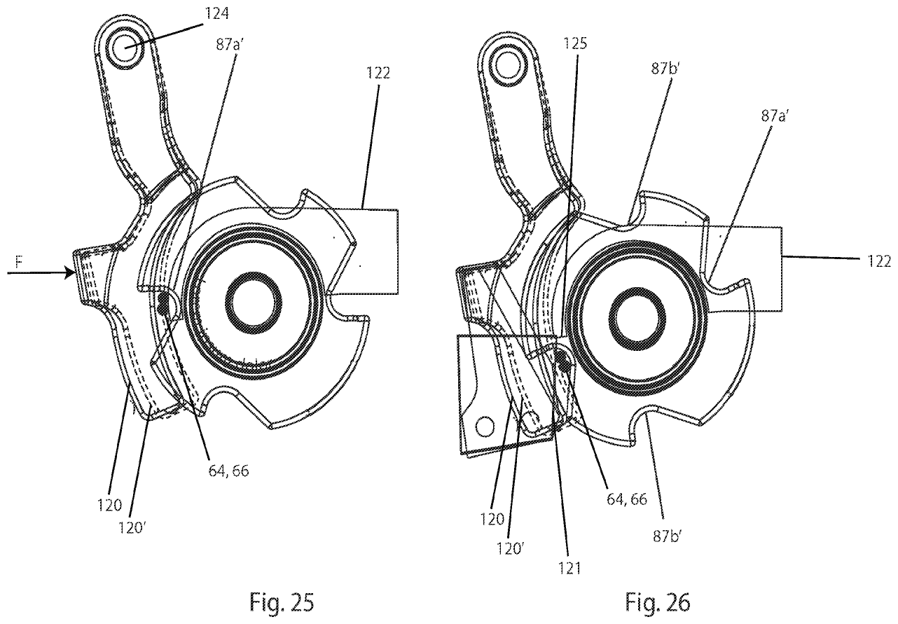

FIG. 25 shows a variant to the twine holder of FIG. 18, wherein each rotary disk has asymmetrically positioned notches;

FIG. 26 shows a variant to the twine holder of FIG. 19, wherein each rotary disk has asymmetrically positioned notches;

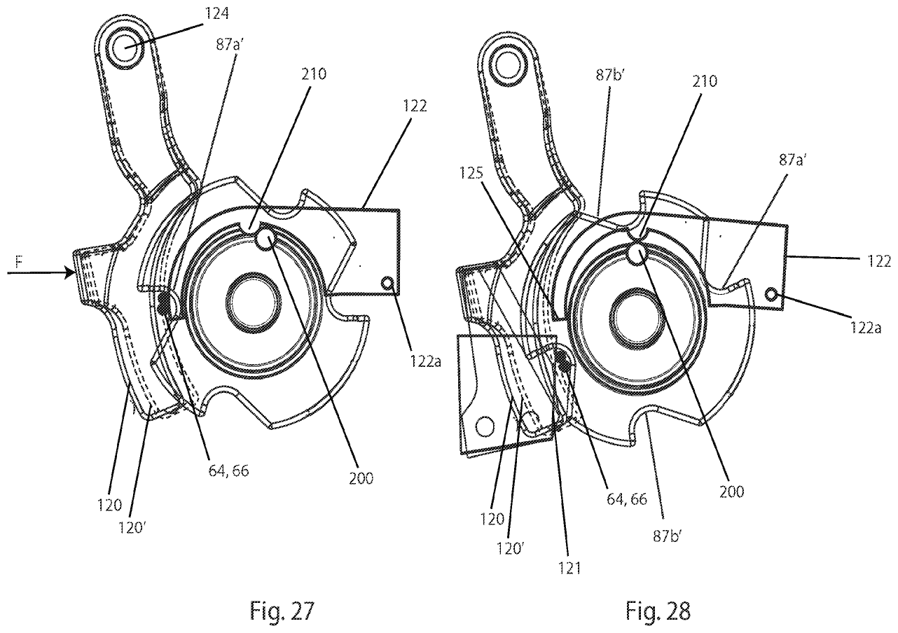

FIG. 27 is a side view of a twine holder, for use in a second embodiment of the invention, wherein a clamping plate is pivotally attached to a mounting and is arranged to pivot with respect to first and second rotary disks, wherein the clamping plate is shown in a first operational orientation; and

FIG. 28 is a side view of the twine holder in FIG. 27, wherein the clamping plate is shown in a second operational orientation.

A baler according to the invention is shown in FIG. 1. The baler includes a baling chamber 26 that is defined by a baling casing 22 comprising top and bottom plates 3 and two side walls 4, one of which has been omitted from the drawing to show the interior of the chamber 26. The baling chamber 26 comprises a channel having an inlet end 6 and an outlet end 8. At the inlet end 6, the channel is closed by a plunger 30 that can be driven into the baling chamber 26 in a reciprocating manner. In this example, the plunger 30 is driven from a rotating drive axle 12 via a pair of drive arms 14, 16. Bales B are formed in the baling chamber.

In addition, the baler includes a pick up mechanism A for picking up cut bale material (for example grass and straw) from the ground, a feed mechanism E for feeding the bale material into the baling chamber 26, the feed mechanism having a feed duct 28, a set of needles 42 for feeding binding twine through the baling chamber 26 and a drive mechanism D for transmitting drive to the drive axle 12 from the drive output of a towing vehicle (not shown). These components are all conventional and so will not be described in detail.

The baler shown in FIGS. 1 and 2 is similar in many respects to the baler described in EP-1584227-A1 or WO 2022/023530, the entire content of both documents are incorporated by reference herein. Bale material is introduced into the bale chamber 26 through the feed duct 28. The plunger 30 compresses bale material in the bale chamber to produce the bale B. As the bale is produced, two twines 64,66 are drawn from twine sources 73,74 and laid along the upper and lower sides of the bale, as shown in FIG. 3. Upon completion of the bale B, the twines 64, 66 are brought together by a needle 42 and the two twines 64,66 are tied together by a knotter 40, which is driven via a clutch 38, to form a twine loop 62 that is stretched around the bale B to maintain the bale material in compression after the bale is ejected from the bale case 22. In this example, the knotter 40 includes a rotary bill hook 82, which is configured to tie two knots successively during each complete operating cycle. As illustrated in FIG. 3, a first knot 70 is tied to complete the twine loop 62 around the completed bale B and a second knot 72 is then tied to start a new twine loop 62a for the next bale. The twines are severed between the two knots 70, 72. In this example, the first and second knots 70,72 are both right-handed knots and they are tied successively by the same bill hook. Also, in this example, the second knot 72 is a loop knot, whereas the first knot 70 is a conventional knot. The strength of the twine loop is therefore limited by the strength of the conventional first knot 70, which has a lower breaking strength than the loop knot that forms the second knot 72. Alternatively, in certain embodiments of the invention, the first knot 70 and the second knot 72 may both be loop knots.

The binding system and the method for binding a bale according to the present invention are similar in most respects to the binding systems and the methods for binding bales described in EP-1584227-A1 or WO 2022/023530.

However, in certain embodiments of the present invention, the first knot and the second knot are both loop knots.

In certain other embodiments, the second knot 72 is a loop knot and the first knot 70 is a conventional knot.

A knotter 40 according to an embodiment of the present invention is shown in more detail in FIGS. 4 to 6. The knotter 40 is similar in many respects to the knotter described in EP-1584227-A1 and therefore will not be described in full detail.

The knotter 40 comprises a circular drive disk 76 that is attached through a hub 77 to a drive shaft 78. The knotter 40 also comprises a frame 80, a rotary bill hook 82 mounted on an end of a shaft 82a for rotation about an axis 84, and a twine holder 86 having at least one rotary disk 86a,86b that has a plurality of notches 87 in its perimeter for holding the twines against a retainer 120. Typically, the twine holder 86 includes a first rotary disk 86a and a second rotary disk 86b, each of which has a plurality of notches 87 formed in its perimeter. The knotter 40 includes a release assembly 95, which is pivotable to cut the twines 64,66 when forming the first knot and to release the twines 64,66 from the twine holder 86 when forming the second knot. The release assembly 95 includes a cutter 94 for severing the twine strands 64,66. The release assembly 95 also includes a stripper arm 92, which can be actuated to strip each of the first and second knots from the bill hook 82. Pivoting movement of the release assembly 95 is controlled by a cam follower 89 that engages a cam track 90 in the drive disk 76.

The rotary bill hook 82, which is shown in more detail in FIGS. 7 and 8a-8d, includes a fixed lower lip 83b and a pivotable upper lip 83a. The lower lip 83b is fixed to the shaft 82a, towards one end thereof. The pivotable upper lip 83a includes a twine retaining formation 96, which is sometimes referred to as a catching element 96. The catching element is located towards a distal end of the upper lip 83a and is oriented downwards towards the lower lip 83b. The catching element 96 moves with the upper lip 83a, as the upper lip 83a pivots. Typically, the catching element 96 is an integral part of the upper lip 83a. The pivotable upper lip 83a moves between open and closed configurations and is controlled by a cam follower 85, which engages a cam track 91 provided on a collar 93 that surrounds the bill hook shaft 82a. Rotation of the bill hook 82 about the axis 84 is driven by a pinion 88 that engages first and second gear stretches 98,100 on the drive disk 76.

The rotary disks 86a,86b of the twine holder 86 are driven by a worm gear 101, a worm screw 102 and a bevel gear 103 that engages third and fourth gear stretches 104, 105 on the drive disk 76.

Operation of the knotter 40 is substantially as described in EP-1584227-A1, except as described below.

The bill hook 82 is rotatable between a first position in which the bill hook engages the twines and a second position in which a knot formed by the knotter 40 is stripped from the bill hook 82 by the stripper arm 92. The upper lip 83a is configured in a closed configuration to retain a twine to the bill hook 82 or an open configuration to release the twine from the bill hook 82. If a conventional knot is being formed on the bill hook 82, the upper lip 83a can remain closed. In this condition, short twine ends will be pulled through the partially formed knot to make the conventional knot. If a loop knot is being formed on the bill hook, the upper lip 83a can be configured to adopt the open configuration to release the retained twine from the bill hook 82 after the knot is removed from the bill hook 82 by the stripper arm 92, so that the cut end of the twine is not pulled through the knot. In this embodiment the upper lip 83a is biased by a resilient biasing element 108 towards the closed configuration and is moved to the open configuration by an opening assembly 97, which comprises the collar 93 and the cam follower 85.

The upper lip 83a can thus be opened to release the twine without rotating the bill hook 82 beyond the second position. Alternatively, it is also possible that the upper lip 83a is not biased by the resilient biasing element 108 towards the closed configuration and the cupper lip 83a is normally open and only closed by the strands of the twine 64,66.

Alternatively, the upper lip 83a can be moved passively to the open configuration. For example, opening of the upper lip 83a can be achieved by inactivating the resilient biasing element 108 or reducing/counteracting the biasing force, so that the upper lip 83a is moved to the open configuration by tension in the twine. Inactivating the resilient biasing element 108 or reducing/counteracting the biasing force can be achieved for example by modifying the configuration of the resilient element 108 so that only at the position of the bill hook 82 where the knot is stripped off (and not if it is turned to form the knot) the upper lip 83a is not affected by the resilient biassing element 108 and the upper lip 83a is free to move (partly) upward. When the knot is formed and not yet stripped off the bill hook 82 the twine that is wound around the bill hook 82 will hold the upper lip 83a, and hence catching element 96, down. As soon as the knot is stripped off the bill hook 82 the upper lip 83a, and hence the catching element 96 is then free to move upward. This also is the case when the upper lip 83a has a normally open position without a resilient element 108 to hold the upper lip 83a in the closed position. The upward movement of the upper lip 83a may result as a reaction to the pulling force of the twine loop but could alternatively also be assisted by an additional counter-biasing resilient element.

If the bill hook 82 is turned for forming the loop the resilient biassing element 108 will force the catching element down.

The process of producing the knot is well described in text and pictures of WO2018202588A1, the entire content of which is incorporated by reference herein, and in WO 2022/023530.

The knotter 40 comprises a set of individual knotters provided crosswise on top of the hale chamber 26 at intervals. Each knotter has an associated needle 42 for forming an individual loop around a finished bale B. A dog clutch connects the knotters and their needles 42 to a drive source to commence a tying operation.

The twine holder 86 is mounted next to the bill hook 82. The needle 42 swings back and forth across the bale chamber 26 to deliver twine to the knotter. In particular, the needle 42 delivers twine to the twine holder 86 and to the bill hook 82 during operation of the knotter 40.

The twine holder 86 preferably includes first and second disks 86a, 86b. The first and second disks 86a,86b are fixed together via a central hub and are locked for rotation with one another. Each disk 86a,86b is provided with at least two notches, which includes a second notch 87a,87a′ and a first notch 87b,87b′. In some embodiments, each rotary disk 86a,86b has a least two second notches 87a,87a′ and at least two first notches 87b,87b′. The rotary disks 86a,86b are typically fixed to one another such that the second notches 87a in the first rotary disk 86a are aligned with respective second notches 87a′ in the second rotary disk 86b, and the first notches 87b in the first rotary disk 86a are aligned with respective first notches 87b′ in the second rotary disk 86b.

In an embodiment of the invention, the twine holder 86 is configured to release the twines timely when the bill hook 82 has finished its second turn to complete the knot and before or at the moment the knot is fully pushed/pulled off the bill hook 82 by the stripper arm 92. This helps to prevent the possibility that there will be loose twine ends or “tails” (waste) that will pollute the fodder or the environment. By releasing the twines 64,66 the loop of the second knot of the binding cycle will have longer ends. The release of the twines is achieved by the twine holder 86 described below.

In use, the needle 42 drapes the twines 64,66 across the billhook 100 and into the first clamping notches 87b,87b, Rotation of the first and second rotary disks 86a,86b firmly grips the twines 64,66 between the disks and the retainer 120 and prevents them from escaping as the billhook 82 commences rotation. For example, the rotary disks 86a,86b may rotate a quarter of a turn to clamp the twines 64,66 in the first clamping notches 87b,87b′. At this time, the needle 42 moves downward wherein the two twines 64,66 on a rear side of the needle 42 are placed in the successive second notches 87a,87a′ of the rotary disk for the second knot. While the needle 42 retracts, the billhook 82 continues to rotate to form the first knot. During this further rotation of the billhook 82, the billhook 100 opens again to enable the twines from first clamping notches to be positioned between the upper lip 83a and the lower lip 83b.

In some embodiments, the first notch 87b′ has a different depth from the second notch 87a′. Typically, the second notch 87a′ has a greater depth from the outer periphery of the rotary disk than the first notch 87b′. As in the prior art, during knot forming operations the twines 64,66 are placed in the notches 87a′,87b′ by the needle 42, as described in more detail below. The disks 86a,86b cooperate with a retainer 120. The retainer 120 comprises an arm, which is pivotally attached to a mounting, such as a frame, at a pivot axis 124. Typically, the pivot axis 124 is located towards one end of the arm. The retainer 120 includes a longitudinal recess that is arranged to receive peripheral parts of the first and second rotary disks 86a,86b. The retainer 120 is resiliently biased towards a center 126 of the disks 86a,86b, which is the pivot axis 126 of the rotary disks. By rotating the disks 86a, 86b, in the direction R, the twines 64,66 are clamped by the notches 87a′,87b′ in the disks 86a, 86b and the retainer 120 in the manner described below.

Rotation of the disks 86a,86b in the direction R shown in FIG. 14 positions the twines 64,66 correctly relative to the rotating bill hook 82 and the cutter 94. In the prior art, the disks 86 rotate 90 degrees during the formation of the first and second knots and the disk has 4 notches. Each disk 86a,86b according to some embodiments of the invention include two regular depth first notches 87b′ positioned at 180 degrees relative to each (i.e. diametrically opposite one another) other, and two second notches 87a′ with an extended depth. Each second notch 87a′ is located between the pair of first notches 87b′. The second notches 87a′ are preferably arranged diametrically opposite one another.

Each first notch 87b′ has a depth that is similar to the state of the art twine holders. This first notch 87b′ holds the twines 64,66 in cooperation with the retainer 120 that is biased towards the disks 86a,86b by a resilient element (not shown) during the formation of the first knot. Since the second notch 87a′ has a substantially greater depth, that is, in FIG. 16, the radial distance Ra′ from a central axis 126 of the disk is smaller than the radial distance Rb′ from the central axis 126 of the disk, relative to the outer circumference of the disk 86a,86b. The difference in notch depth results in a biassing force F (see FIG. 15) generated by the resiliently biased retainer 120 on the clamped twines 64,66 in the second notches 87a′ that is substantially lower than the biassing force F applied to the twines 64,66 in the first notch 87b′ at least during the end of the rotation of the bill hook 82 during the formation of the second knot (120′) compared to the first knot (120).

In order to hold the twines 64,66 during a first part of the rotation of the bill hook 82 during the second knot forming cycle, the extended depth of the second notch 87a′ in cooperation with the retainer 120 is not able to hold the twines 64,66 sufficiently and therefore twine holder (the disks 86a,86b and retainer 120) are also provided with a clamping member, for example in the form of a clamping plate 122 positioned between the first and second disks 86a,86b. The clamping plate 122 is rotationally fixed to a mounting (not shown), and therefore the first and second rotary disks 86a,86b rotate relative to the clamping plate 122. An outer surface of the clamping plate 122 is curved. In preferred arrangements the outer surface is arcuate and has a radius Rp, from the central axis 126 of the rotary disks, that is approximately equal to the radius Rb of the of the first notch 87b′. The radius Rp is at least greater than the radius Ra of the lower part of the extended depth of the second notch 87a′. The extended depth of the second notch 87a′ is compensated for by the clamping plate 122, in the following manner. The clamping plate 122 cooperates with the retainer 120 and clamps the twines 64,66 during the first part of the formation of the second knot while the second notch 87a′ with the extended depth is moving the twines 64,66 between the clamping plate 122 and the retainer 120 so as to position the twines 64,66 correctly relative to the bill hook 82. At the end of the second knotting cycle (see FIGS. 20 and 28) the rotary disks 86a,86b will position the twines 64,66 just beyond the end 125 of the clamping plate 122 and then the twines 64,66 will ‘fall’ into the second notch 87a′ with the extended depth. The second notch 87a′ with the extended depth, together with the retainer 120, is not able to hold the twines 64,66 sufficiently firmly, which prevents the cutter 94 from cutting the twines 64,66, instead the twines 64,66 are pulled out of the second notch 87a′ and the retainer 120 by the cutter 94. The second knot created has longer ends that are not pulled through the knot, accordingly a loop knot is formed and there is no waste of twine ends.

Optionally, the clamping plate 122 can have an inner curved surface, for example the inner curved surface is complementary to an outer curved surface of the hub connecting the first rotary disk 86a to the second rotary disk 86b. This enables the clamping plate 122 to wrap around an arcuate sector of the hub, which helps facilitate a good clamping arrangement with the retainer 120. Moving the twines 64,66 beyond the clamping plate 122 can be realized by at least one extra gear stretch (not shown) mounted on the drive disk 76 after the gear stretch 105 for the second knot.

In an embodiment of the invention, releasing the twine ends by the twine holder 86 can be achieved by positioning the first and second notches 87a, 87b in the twine holder disk 86 asymmetrically (not at 90 degrees), for example as illustrated in FIG. 9, and FIGS. 21-26 so as to have the twines held for the first knot between the first notch 87b 87b′ and the retainer 120, and to have the second notch 87a,87a′ positioned (at rest) just beyond the clamping plate 122. For example, the notches 87a, 87a′, 87b, 87b′ may be displaced at angles of approximately 65-70 degrees and 110-115 degrees, as illustrated in FIG. 9 and FIG. 21-26. This arrangement helps ensure that the twines 64,66 are positioned beyond the clamping plate 122 at the end of the second knot for cycle.

In some embodiments, as illustrated in FIGS. 12 and 13, a screen 121 may be configured so that the twine 64 is guided across the screen 121 in two different positions, depending on the rotational position of the twine holder 86. For example, as shown in FIG. 12 in a first position of the twine holder 86 for tying the first knot the twine 64 is guided across the screen 121 in a high position, where it can be contacted by the cutter 94. For example, the first position can be located on an upper surface of the screen 121. As a result, the twine 64 is cut when the cutter 94 is activated. Alternatively, as shown in FIG. 13 in a second position of the twine holder 86 for tying the second knot the twine 64 is guided across the screen 121 in a low position, where it cannot be contacted by the cutter 94. As a result, the twine 64 is not cut by the cutter 94, allowing it to be pulled through the twine holder 86. For example, the screen can have a side surface that is arranged perpendicularly to the upper surface and the second position can be located on the side surface. The screen 121 does not have a cutting edge and therefore does not cut the twine 64.

Operation of the knotter 40 will now be described. When forming the first knot, the twines 64,66 are inserted into the first clamping notches 87b,87b′ (see FIG. 15—symmetric rotary disks; and FIG. 21—asymmetric rotary disks). The drive system rotates the first and second rotary disks 86a,86b to clamp the twines 64,66 between the retainer 120 and the clamping plate 122 (see FIG. 16—symmetric rotary disks; and FIG. 22—asymmetric rotary disks). The drive system rotates rotary bill hook 82 to wrap the twines 64,66 about the bill hook thereby tying the first knot in the twines 64,66. The stripper arm 92 is actuated to strip the first knot from the rotary bill hook 82. The cutter 94 cuts the twines 64,66. Optionally, the stripper arm 92 includes the screen and the twines 64,66 are positioned in the first position across an upper surface of the screen 121.

When forming the second knot, the twines 64,66 are inserted into the second clamping notches 87a,87a′ (see FIG. 17—symmetric rotary disks; and FIG. 23—asymmetric rotary disks). The drive system rotates the first and second rotary disks 86a,86b to clamp twines 64,66 between the retainer 120 and the clamping plate (see FIG. 18—symmetric rotary disks; and FIG. 24—asymmetric rotary disks). In this condition, the twines do not contact the deepest part of the second clamping notches 87a,87a′. The drive system rotates rotary bill hook 82 to wrap the twines 64,66 about the bill hook thereby tying the second knot in the twines 64,66, which comprises a loop knot. As the second knot is nearing completion, the drive system rotates the first and second rotary disks 86a,86b such that the twines 64,66 slide over the curved outer surface of the clamping plate 122. As the twines 64,66 move past the end of the curved surface, and hence the end of the clamping plate 122, the twines fall into the deepest part of the second clamping notches 87a,87a′ (see FIG. 20—symmetric rotary disks; and FIG. 26—asymmetric rotary disks). And the retainer 120 releases the twines 64,66, or at least significantly reduces the clamping force applied to the twines 64,66. The stripper arm 92 is actuated to strip the second knot from the rotary bill hook 82. The cutter 94 does not cut the twines 64,66 since the twines 64,66 are not tightly clamped by the retainer 120 and rotary disks 86a,86b. Optionally, the twines 64,66 are positioned in the second position across the screen 121.

In some embodiments, the clamping plate 122 is pivotable about a pivot axis 122a. For example, the clamping plate 122 can be pivotally attached to a mounting such as a frame. The pivotable mounting plate 122 enables the clamping force applied to the twines 64,66 to be adjustable. For example, it is possible to reduce the clamping force applied to the twines 64,66 at a particular time during the knot forming cycle to more precisely control the time at which the twines 64,66 are released. This helps to ensure, for example, that both twines 64,66 are released together rather than one at a time. This helps to improve the quality of the knot formed. The twine holder 86 can include a first actuation formation 200 and the clamping plate 122 can include a second actuation formation 210. The first actuation formation 200 can be attached to at least one of the first rotary disk 86a, the second rotary disk 86b and the hub that connects the first and second rotary disks 86a,86b together. The second actuation formation 210 can be located on an inner face of the clamping plate, that is a face that is oriented towards the hub. The first actuation formation 200 can comprise a first protrusion. The second actuation formation 210 can comprise a second protrusion. As the rotary disks 86a,86b and hub rotate relative to the clamping plate 122, the first actuation formation 200 rotates relative to the second actuation formation 210. The first actuation formation 200 is arranged to engage the second actuation formation 210 in a condition when the formations are rotationally aligned, thereby causing the clamping plate 122 to pivot away from the hub and releasing, or at least significantly reducing, the clamping force applied to the twines 64,66. Thus the twines 64,66 are no longer tightly clamped by the twine holder 86 within the second clamping notches 87a,87a′.

With this embodiment, it is not strictly necessary to have first and second clamping notches 87a,87b,87a′,87b′ which have different depths, that is, the depth of the first notches 87b,87b′ can be equal to the depth of the second notches 87a,87a′. However, it can be beneficial to use the pivotable clamping plate 122 in conjunction with second notches 87a,87a′ having a different depth from the first notches 87b,87b′, in order to better control the knot forming process.

It will be appreciated by the skilled person that modifications can be made to the above embodiments that fall within the scope of the invention, for example the twine holder can include any suitable number of rotary disks.

The description presents exemplary embodiments and, together with the drawings, serves to explain principles of the invention. However, the scope of the invention is not intended to be limited to the precise details of the embodiments or exact adherence with all method installation steps, since variations will be apparent to a skilled person and are deemed also to be covered by the claims. Terms for components used herein should be given a broad interpretation that also encompasses equivalent functions and features. In some cases, several alternative terms (synonyms) for structural features have been provided but such terms are not intended to be exhaustive.

Descriptive terms should also be given the broadest possible interpretation. For example, the term “comprising” as used in this specification means “including” such that interpreting each statement in this specification that includes the term “comprising”, features other than that or those prefaced by the term may also be present. Related terms such as “comprise” and “comprises” are to be interpreted in the same manner. Directional terms such as “vertical”, “horizontal”, “up”, “down”, “upper” and “lower” may be used for convenience of explanation usually with reference to the illustrations and are not intended to be ultimately limiting if an equivalent function can be achieved with an alternative dimension and/or direction.

The description herein refers to embodiments with particular combinations of configuration steps or features, however, it is envisaged that further combinations and cross-combinations of compatible steps or features between embodiments will be possible. Indeed, isolated features may function independently as an invention from other features and not necessarily require implementation as a complete combination. Any feature from an embodiment can be isolated from that embodiment and included in any other embodiment.

The term “at least one of” is to be interpreted in the sense of “and/or”. For example, the term “at least one of the first notch and the second notch” is to be interpreted as meaning any one of the following: the first notch alone; the second notch alone; or the combination of the first and second notches. As another example, the term “at least one of the first notch, the second notch and the hub” is to be interpreted as meaning any one of the following: the first notch alone; the second notch alone; the hub alone; the combination of the first notch and the second notch; the combination of the first notch and the hub; the combination of the second notch and the hub; or the combination of the first notch, the second notch and the hub.

1. A baler comprising a bale forming chamber, a reciprocating plunger configured to compress bale material in the bale forming channel to form a bale and a binding system for binding the bale in a bale forming channel of a baler with a pair of twines that pass around opposite sides of the bale, the binding system including: a knotter including a rotary bill hook having a rotational axis, a twine holder, a twine cutter and a stripper element arranged to remove at least some knots from the bill hook; wherein the binding system is configured to tie a first knot and a second knot successively in the twines during one full operating cycle of the binding system, at least the second knot is a loop knot, wherein the bill hook is rotatable between a first position in which the bill hook engages the twines and a second position in which a knot formed by the knotter is stripped from the bill hook by the stripper element; the twine holder comprising a first rotary disk including a first clamping notch arranged to receive the twines during formation of the first knot and a second clamping notch arranged to receive the twines during formation of the second knot, a retainer positioned adjacent a periphery of the first rotary disk arranged to cooperate with the first rotary disk to hold the twines at least during a part of the operating cycle, a clamping plate arranged to cooperate with the retainer to hold the twines, at least until the second knot is stripped off the bill hook by the stripper element, wherein the binding system includes a drive system for rotating the first rotary disk to clamp the twines in one of the first and second notches against the retainer and/or clamping plate, wherein the retainer and/or clamping plate, at least during the stripping off of the knots by the stripper element, is arranged to apply a greater clamping force on the twines in a condition wherein the twines are located in the first clamping notch than the clamping force applied on the twines in a condition wherein the twines are located in the second clamping notch.

2. The baler of claim 1, wherein the depth of the second clamping notch, relative to an outer circumference of the first rotary disk, is greater than the depth of the first clamping notch.

3. The baler of claim 1, wherein the twine holder includes a second rotary disk, the second rotary disk is fixed for rotation with the first rotary disk about a rotation axis, the second rotary disk includes a first clamping notch and a second clamping notch, and the clamping plate is arranged to cooperate with the retainer to hold the twines located in one of the notches of the second rotary disk.

4. The baler of claim 3, wherein the first and second rotary disks are fixed to one another such that at least one first notch in the first rotary disk is rotationally aligned with at least one first notch in the second rotary disk and such that at least one second notch in the second rotary disk is rotationally aligned with at least one second notch in the second rotary disk.

5. The baler of claim 3, wherein the clamping plate is positioned between the first and second rotary disks.

6. The baler of claim 1, wherein the first rotary disk is arranged to rotate relative to the clamping plate.

7. The baler of claim 1, wherein the retainer is resiliently biased towards the center of the first rotary disk.

8. The baler of claim 1, wherein in a condition wherein the twines are located in the second notch of the first rotary disk, and the second knot is being stripped off by the stripper element, the first rotary disk is arranged to rotate the twines beyond an end of the clamping plate, thereby releasing the twines from the grip of the clamping plate and the retainer.

9. The baler of claim 1, wherein at least part of the clamping plate includes a curved outer surface, in a condition wherein the twines are located in the second notch, the first rotary disk is arranged to rotate the twines beyond the curved outer surface, thereby releasing the twines from the grip of the clamping plate and the retainer.

10. The baler of claim 9, wherein the curved outer surface comprises an arc having a radius that extends from a rotation axis of the first rotary disk.

11. The baler of claim 10, wherein the radius defining the arc of the outer surface of the clamping plate, has a radial distance that is less than or equal to a radial distance from the rotation axis of the first rotary disk to the inner most part of the first notch; and/or the radius defining the arc of the outer surface of the clamping plate, has a radial distance that is greater than the radial distance from the rotation axis of the first rotary disk to the inner most part of the second notch.

12. The baler of claim 1, wherein the first rotary disk includes a plurality of first clamping notches and a plurality of second clamping notches, and the first and second notches alternate around the periphery of the first rotary disk.

13. The baler of claim 12, wherein the clamping notches are arranged asymmetrically around the periphery of the first rotary disk.

14. The baler of claim 1, wherein the stripper element includes a screen arranged to move with the stripper element, wherein the screen is arranged to support the twines during at least part of the first knot forming process and/or to support the twines during at least part of the second knot forming process.

15. The baler of claim 14, wherein twine is located in first and second different positions on the screen depending on the rotational position of the rotary disk, the first position is a position in which the twine is cuttable by the cutter, and the second position is a position in which the twine is not cuttable by the cutter.

16. The baler of claim 14, wherein the screen includes an upper surface, and the first position is located on the upper surface, the screen includes a side surface arranged perpendicularly to the upper surface and the second position is located on the second surface.

17. The baler of claim 9, wherein rotation of the second notch beyond an end of the clamping plate and/or beyond the curved outer surface is achieved by locating an additional gear stretch on a drive disk after a gear stretch for operating the first rotary disk.

18. The baler of claim 1, wherein the first knot comprises a loop knot.

19. The baler of claim 1, wherein the clamping plate is pivotally attached to a mounting and is arranged to pivot with respect to the first rotary disk to a position wherein the twines are released from the twine holder.

20. The baler according to claim 19, wherein the twine holder includes an actuation formation that is arranged to actuate the clamping plate thereby causing the clamping plate to pivot to the position wherein the twines are released from the twine holder.

21. A method for binding a bale in a baler, the method including: providing a baler comprising a bale forming channel, a reciprocating plunger that compresses bale material in the bale forming channel to form a bale, and a binding system that binds a bale in the bale forming channel with a pair of twines that pass around opposite sides of the bale, the binding system comprising a drive system and a knotter that includes a rotary bill hook that has a rotational axis, a twine cutter, and a twine holder having a first rotary disk including a first clamping notch and a second clamping notch, a retainer, and a clamping member having a curved outer surface; tying a first knot and a second knot successively in the twines during one full operating cycle of the binding system, including: when forming the first knot, locating the twines in the first clamping notch; clamping the twines between the retainer and the clamping member; the rotary bill hook tying a first knot in the twines; the cutter cutting the twines; when forming the second knot, locating the twines in the second clamping notch; the drive system rotating the first rotary disk to clamp twines, the retainer clamping the twines to the curved outer surface of the clamping member as the twines move over the curved surface of the clamping member; the bill hook tying a second knot wherein the second knot is a loop knot; the retainer releasing the twines, or at least significantly reducing the clamping force applied to the twines, towards the end of the second knot forming cycle as the twines pass an end of the clamping member and/or an end of the curved surface of the clamping member, thereby preventing the twine cutter from cutting the twines.

22. The method of claim 21, wherein the binding system includes a stripping element arranged to strip the first and/or second knot from the bill hook, the stripping element includes a screen; locating twine on the screen in a first position when forming the first knot; locating twine on the screen in a second position when forming the second knot.

23. The method of claim 21, wherein the baler comprises a bale forming chamber, a reciprocating plunger configured to compress bale material in the bale forming channel to form a bale and a binding system for binding the bale in a bale forming channel of a baler with a pair of twines that pass around opposite sides of the bale, the binding system including: a knotter including a rotary bill hook having a rotational axis, a twine holder, a twine cutter and a stripper element arranged to remove at least some knots from the bill hook; wherein the binding system is configured to tie a first knot and a second knot successively in the twines during one full operating cycle of the binding system, at least the second knot is a loop knot, wherein the bill hook is rotatable between a first position in which the bill hook engages the twines and a second position in which a knot formed by the knotter is stripped from the bill hook by the stripper element; the twine holder comprising a first rotary disk including a first clamping notch arranged to receive the twines during formation of the first knot and a second clamping notch arranged to receive the twines during formation of the second knot, a retainer positioned adjacent a periphery of the first rotary disk arranged to cooperate with the first rotary disk to hold the twines at least during a part of the operating cycle, a clamping plate arranged to cooperate with the retainer to hold the twines, at least until the second knot is stripped off the bill hook by the stripper element, wherein the binding system includes a drive system for rotating the first rotary disk to clamp the twines in one of the first and second notches against the retainer and/or clamping plate, wherein the retainer and/or clamping plate, at least during the stripping off of the knots by the stripper element, is arranged to apply a greater clamping force on the twines in a condition wherein the twines are located in the first clamping notch than the clamping force applied on the twines in a condition wherein the twines are located in the second clamping notch.
